(19) United States
(12) Patent Application Publication
(10) Pub. No.: US 2025/0225678 A1
(43) Pub. Date: Jul. 10, 2025

(54) POSE DETERMINATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Tianyang SHI, Beijing (CN); Haozhou PANG, Beijing (CN)

(21) Appl. No.: 18/974,610

(22) Filed: Dec. 9, 2024

(30) Foreign Application Priority Data
Jan. 10, 2024 (CN) 202410039685.4

(51) Int. Cl. G06T 7/73

(52) U.S. Cl. CPC G06T 7/74; G06T 2207/20084

(57) ABSTRACT

Embodiments of the present disclosure provide a pose determination method and apparatus, an electronic device, and a storage medium. The method includes: obtaining current object information of a target object and historical state information of a target element, where the current object information is object information of the target object in a current image frame, the historical state information is state information of the target element in a historical image frame, and the target element is associated with the target object; and determining current pose information of the target element based on the current object information and the historical state information, where the current pose information is pose information of the target element in the current image frame.

### CROSS-REFERENCE TO RELATED APPLICATION(S)

This application claims priority to Chinese Application No. 202410039685.4 filed on Jan. 10, 2024, the disclosure of which is incorporated herein by reference in its entity.

### TECHNICAL FIELD

Embodiments of the present disclosure relate to the field of computer technologies, and in particular, to a pose determination method and apparatus, an electronic device, and a storage medium.

### BACKGROUND

In real-time interactive scenarios, an object or element in an image frame needs to be accurately simulated to improve the effect of the entire image. For example, in the field of games or virtual fitting, cloth is prone to bending deformation to generate folds of different degrees.

### SUMMARY

In a first aspect, embodiments of the present disclosure provides a pose determination method, including:
obtaining current object information of a target object and historical state information of a target element, where the current object information is object information of the target object in a current image frame, the historical state information is state information of the target element in a historical image frame, and the target element is associated with the target object; and
determining current pose information of the target element based on the current object information and the historical state information, where the current pose information is pose information of the target element in the current image frame.

In a second aspect, embodiments of the present disclosure further provides a pose determination apparatus, including:
an obtaining module, configured to obtain current object information of a target object and historical state information of a target element, where the current object information is object information of the target object in a current image frame, the historical state information is state information of the target element in a historical image frame, and the target element is associated with the target object; and
a determination module, configured to determine current pose information of the target element based on the current object information and the historical state information, where the current pose information is pose information of the target element in the current image frame.

In a third aspect, an embodiment of the present disclosure further provides an electronic device, including:
one or more processors;
a memory, configured to store one or more programs,
where the one or more programs, when executed by the one or more processors, cause the one or more processors to implement the pose determination method according to the embodiments of the present disclosure.

In a fourth aspect, embodiments of the present disclosure further provides a computer-readable storage medium, having a computer program stored thereon, where the program, when executed by a processor, causes the pose determination method according to the embodiments of the present disclosure to be implemented.

### BRIEF DESCRIPTION OF THE DRAWINGS

The above and other features, advantages, and aspects of embodiments of the present disclosure become more apparent with reference to the following specific implementations in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a pose determination method according to embodiments of the present disclosure;

FIG. 2 is a schematic flowchart of another pose determination method according to embodiments of the present disclosure;

FIG. 3 is a schematic flowchart of another pose determination method according to embodiments of the present disclosure;

FIG. 4 is a schematic diagram of a structure of a pose determination apparatus according to embodiments of the present disclosure; and

FIG. 5 is a schematic diagram of a structure of an electronic device according to embodiments of the present disclosure.

### DETAILED DESCRIPTION

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. Additionally, additional steps may be included and/or the execution of the illustrated steps may be omitted in the method implementations. The scope of the present disclosure is not limited in this regard.

The term “include/comprise” used herein and the variations thereof are an open-ended inclusion, that is, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The relevant definitions of other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or the interdependence.

It should be noted that the modifiers “one” and “a plurality of” mentioned in the present disclosure are illustrative and not restrictive, and those skilled in the art should understand that, unless the context clearly indicates otherwise, they should be understood as “one or more”.

The names of messages or information exchanged between a plurality of apparatuses in the implementation of the present disclosure are used for illustrative purposes only, and are not used to limit the scope of these messages or information.

It may be understood that before using the technical solutions disclosed in the embodiments of the present disclosure, users should be informed of the types, usage scope, usage scenarios, and the like of personal information involved in the present disclosure in an appropriate manner in accordance with relevant laws and regulations, and the users' authorization should be obtained.

For example, when receiving an active request from a user, a prompt message is sent to the user to explicitly prompt the user that the operation requested by the user will need to acquire and use the user's personal information. In this way, the user can independently choose whether to provide personal information to a software or hardware such as an electronic device, an application program, a server, or a storage medium that performs the operation of the technical solution of the present disclosure according to the prompt message.

As an optional but non-limiting implementation, the manner of sending a prompt message to the user in response to receiving the active request from the user may be, for example, in a pop-up window, and the prompt message may be presented in text in the pop-up window. In addition, the pop-up window may also carry a selection control for the user to select “Agree” or “Disagree” to provide personal information to the electronic device.

It may be understood that the foregoing notification and obtaining the user's authorization process is only illustrative and does not limit the implementation of the present disclosure. Other manners that meet relevant laws and regulations may also be applied to the implementation of the present disclosure.

It may be understood that the data involved in the technical solution of the present disclosure (including but not limited to the data itself, the acquisition or use of the data) should comply with the requirements of corresponding laws, regulations, and related regulations.

In real-time interactive scenarios, an object or element in an image frame needs to be accurately simulated to improve the effect of the entire image. For example, in the field of games or virtual fitting, cloth is prone to bending deformation to generate folds of different degrees. Therefore, how to accurately determine pose information of an element in a current image frame is a problem that needs to be solved urgently.

An existing pose determination method usually realizes a realistic simulation effect by pre-binding a skeleton to an element model and then calculating the characteristics of the skeleton. However, there are still problems such as relatively low calculation efficiency.

Embodiments of the present disclosure provide a pose determination method and apparatus, an electronic device, and a storage medium, to effectively improve the efficiency of pose determination and solve a problem of dynamic element simulation. The method includes: obtaining current object information of a target object and historical state information of a target element, where the current object information is object information of the target object in a current image frame, the historical state information is state information of the target element in a historical image frame, and the target element is associated with the target object; and determining current pose information of the target element based on the current object information and the historical state information, where the current pose information is pose information of the target element in the current image frame. By using the foregoing technical solution, the current pose information of the target element is determined based on the obtained current object information and historical state information, so that the efficiency of determining element pose information is effectively improved, and a problem of dynamic element simulation is solved.

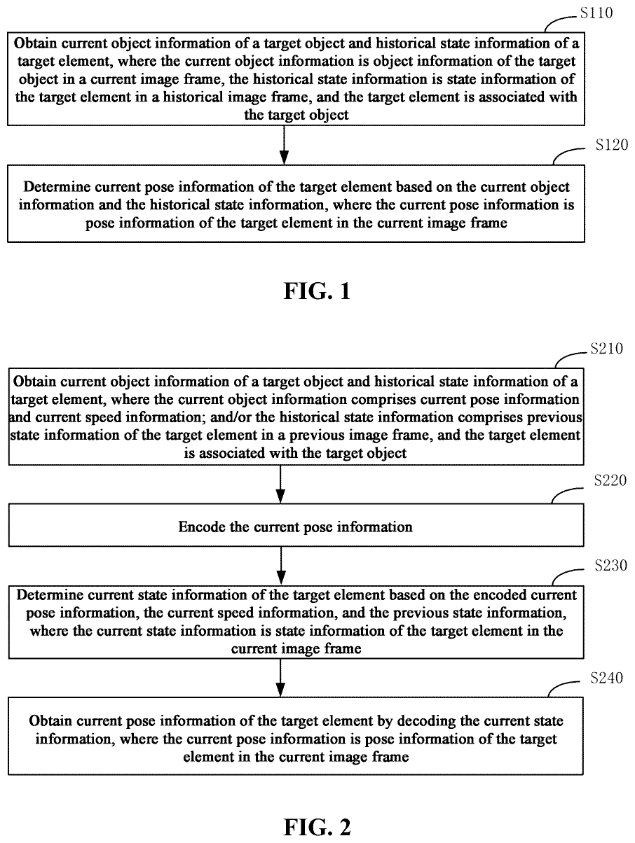

FIG. 1 is a schematic flowchart of a pose determination method according to embodiments of the present disclosure. The method is applicable to a case of determining a pose. The method may be performed by a pose determination apparatus, where the apparatus may be implemented by software and/or hardware, and is generally integrated on an electronic device. In this embodiment, the electronic device includes but is not limited to: a computer, a mobile phone, a tablet computer, or the like.

It may be considered that dynamic elements have always been a difficult topic in the field of simulation due to their complex dynamic characteristics. According to the quality of simulation, the pose determination method can be divided into two types of methods. One is based on complex physical modeling to achieve high-fidelity element simulation. Because a complex differential equation needs to be solved, this type of method usually cannot meet the real-time requirements and is often used in industries that do not pursue simulation efficiency, such as film and television and design. The other is based on a simplified physical model. Usually, a skeleton is pre-bound to an element model, and then the characteristics of the skeleton are calculated, thereby achieving a realistic element simulation effect. It is often used for real-time calculation in games, but there are still problems such as low calculation efficiency and difficulty in supporting multi-person on-image calculation.

In addition, for the application of neural networks in element simulation, there are some relatively mature solutions for static element simulation, but there is no high-performance solution for dynamic element simulation.

Based on this, the pose determination method provided in the embodiments of the present disclosure can effectively improve the efficiency of pose determination and solve the problem of dynamic element simulation. At the same time, different levels of detail (LOD) calculations can be supported without significant loss of effect, thereby effectively reducing the load when a plurality of people are on the same image. Further, because the current new-generation mobile phone chips usually integrate a neural network chip, the embodiments of the present disclosure can also perform operations of the neural network on this chip, thereby further reducing the CPU load. As shown in FIG. 1, a pose determination method provided in an embodiment of the present disclosure includes the following steps:

S110: Obtain current object information of a target object and historical state information of a target element, where the current object information is object information of the target object in a current image frame, the historical state information is state information of the target element in a historical image frame, and the target element is associated with the target object.

The target object may refer to an object in the current image frame, for example, may be any object in the current image frame, or may be an object with some specified characteristics, such as an object including the target element. The target element may be, for example, an element with a flexible characteristic, or may be an element with other characteristics, such as cloth or long hair. The scene of the target object is not limited. In this embodiment, it may be a game scene of a single player or a game scene with a plurality of players on the same image, or may be other film and television or design scenes.

The current object information may be considered as object information of the target object in the current image frame. The object information may refer to information related to the target object, for example, may be current speed information, or may be other information other than the current speed information. The historical state information may be understood as state information of the target element in the historical image frame. The historical image frame may include a previous image frame adjacent to the current image frame, or may include another historical image frame that is not adjacent to the current image frame. The state information may be used to represent a characteristic state of the target element. The target element may be associated with the target object. For example, the target element may be specifically determined by an element in the target object or an element worn by the target object.

In this embodiment, the current object information of the target object and the historical state information of the target element may be first obtained, and then the current pose information is determined based on the obtained information. A specific manner of obtaining the current object information and the historical state information is not limited. For example, different information may correspond to different obtaining manners.

S120: Determine current pose information of the target element based on the current object information and the historical state information, where the current pose information is pose information of the target element in the current image frame.

The current pose information may be pose information of the target element in the current image frame, for example, may be a skeleton parameter of hair or cloth material (such as clothing) in the current image frame.

After the current object information and the historical state information are obtained in the foregoing step, in this embodiment, the current pose information of the target element may be determined based on the obtained current object information and historical state information. For example, the obtained information may be directly input into a preset pose determination model to output the corresponding current pose information, or the current pose information of the target element may be determined by performing certain calculation processing on the obtained current object information and historical state information. Details of the preset pose determination model are not described herein.

In the pose determination method provided in the embodiments of the present disclosure, current object information of a target object and historical state information of a target element are obtained, where the current object information is object information of the target object in a current image frame, the historical state information is state information of the target element in a historical image frame, and the target element is associated with the target object; and current pose information of the target element is determined based on the current object information and the historical state information, where the current pose information is pose information of the target element in the current image frame. By using the method, the current pose information of the target element is determined based on the obtained current object information and historical state information, so that the efficiency of determining element pose information is effectively improved, and a problem of dynamic element simulation is solved.

In some embodiments, the method further includes, after determining current pose information of the target element based on the current object information and the historical state information:

generating the current image frame based on the current object information and the current pose information, where the current image frame is presented with an object image of the target object and/or an element image of the target element.

In some implementations, after the current pose information of the target element is determined, the corresponding current image frame may be further generated based on the current object information and the determined current pose information, so that the current image frame is presented with the object image of the target object and/or the element image of the target element. On this basis, simulation of the target element in the current image frame is realized.

In some embodiments, determining the current pose information of the target element based on the current object information and the historical state information comprises:

inputting the current object information and the historical state information into a preset pose determination model, and obtaining pose information output by the preset pose determination model, as the current pose information of the target element.

The specific architecture of the preset pose determination model is not limited, and for example, may include one or more modules.

In some embodiments, the preset pose determination model comprises an encoding module, a timing module, and at least one decoding module, the encoding module is configured to encode the current pose information in the current object information, the timing module is configured to determine current state information of the target element, and the decoding module is configured to decode the current state information.

The encoding module may be configured to encode the current pose information in the current object information, the timing module may be configured to determine the current state information of the target element, and the decoding module may be configured to decode the current state information. In this embodiment, specific structures and numbers of the encoding module, the timing module, and the decoding module are not limited.

Exemplarily, the preset pose determination model may include a plurality of decoding modules, and the decoding modules may be of a same type or different types. For example, different decoding modules correspond to different target elements, and are configured to obtain current pose information corresponding to target elements by decoding. For example, different decoding modules may correspond to generating current pose information of different parts, and the different parts may correspond to different target elements.

In some implementations, the current pose information may be determined by using the preset pose determination model. That is, the current object information and the historical state information may be directly input into the preset pose determination model, and the corresponding current pose information is output, so that the output pose information may be obtained and determined as the current pose information of the target element.

In some embodiments, the timing module may be a gated recurrent unit, a recurrent neural network module, a long short-term memory neural network module, or a transformer module.

The gated recurrent unit (GRU) introduces a gating mechanism, so that a network can better capture long-term dependence. In addition, the problem of gradient disappearance is reduced, and the calculation amount is small. A recurrent neural network (RNN) is a type of recurrent neural network that uses sequence data as input, performs recursion in the evolution direction of the sequence, and connects all nodes (recurrent units) in a chained manner. The RNN can process variable-length sequence data, and can capture a time dependency relationship in the sequence. In addition, the RNN can also learn context information in the sequence and can perform well in tasks such as natural language processing and speech recognition. The long short-term memory (LSTM) module can process a long-term dependency relationship in a long sequence through a unique gating mechanism, thereby having excellent performance in capturing an internal structure of sequence data. The transformer model can use a self-attention mechanism to capture dependency relationships between different positions, which enables it to process long text sequences. In addition, a long-range dependency problem in a traditional model can be avoided, thereby improving the performance of the model.

In some embodiments, the encoding module and the decoding module are multi-layer perception structures, and each of the multi-layer perception structures comprises a plurality of linear layers, and output sides of at least part of the linear layers are configured with a normalization layer and/or a Gaussian error linear unit.

Specifically, the encoding module and the decoding module may be multi-layer perception structures, that is, each of the encoding module and the decoding module includes a plurality of linear layers. Further, another layer may be added after at least part of the linear layers. For example, a normalization layer and/or a Gaussian error linear unit may be arranged on an output side of one or more linear layers. On this basis, the network precision of the preset pose determination model is improved.

In some embodiments, a loss function of the preset pose determination model comprises a forward dynamics loss function, and the forward dynamics loss function is based on wavelet transform for frequency decomposition.

The loss function of the preset pose determination model is not limited, for example, may include a forward kinematics (FK) loss function. The FK loss function may be obtained based on a transformation of a bone parameter from a local coordinate system to a global coordinate system, and is configured to constrain the model output and the ground-truth to be as equal as possible in the bone position parameter. In addition, when the FK loss function is calculated, wavelet transform may be further introduced. That is, the forward kinematics loss function may be obtained through frequency decomposition based on wavelet transform. For example, a bone point position may be further decomposed according to frequency by using wavelet transform, to improve the effect of high-frequency part prediction of the neural network. In addition, an L1 loss function may also be included, and is configured to constrain the model output and the ground-truth to be as equal as possible in the bone rotation parameter.

In some embodiments, the process of training the preset pose determination model is not limited. For example, in terms of training data collection, because the simulation target of the neural network is a cloth simulation plug-in, a physical simulation result in various action states may be collected in advance in a game environment and used as training data. When training is actually performed, the training data may be preprocessed first. For example, the previously collected training data may be divided into action segments of a fixed length for subsequent training (currently 120 frames, batchsize=64). Then, an adam optimizer is used for optimization. 500 epochs are iterated to make the neural network fully converge. The learning rate is set to 1e-3 and gradually decreases with the number of iteration steps. The training period is about one day.

To further improve the prediction performance of the neural network at a low LOD level (for example, allowing a certain effect loss), the embodiments of the present disclosure may be implemented by scaling the size of the neural network. For example, five LOD models may be trained at the same time. Through the performance improvement in the following table, it can be found that LOD0 is the state with the highest precision.

| LOD | Model bandwidth | Inference speed |
|---|---|---|
| Basic plug-in | / | 0.6 ms |
| 0 | 256 | 0.27 ms |
| 1 | 192 | 0.18 ms |
| 2 | 128 | 0.12 ms |
| 3 | 96 | 0.09 ms |
| 4 | 64 | 0.07 ms |

FIG. 2 is a schematic flowchart of another pose determination method according to embodiments of the present disclosure. The solution in this embodiment may be combined with one or more optional solutions in the foregoing embodiments. Optionally, the current object information comprises current pose information and current speed information; and/or the historical state information comprises previous state information of the target element in a previous image frame.

Determining the current pose information of the target element based on the current object information and the historical state information comprises: encoding the current pose information; determining current state information of the target element based on the encoded current pose information, the current speed information, and the previous state information, where the current state information is state information of the target element in the current image frame; and obtaining the current pose information of the target element by decoding the current state information.

For details not described in this embodiment, refer to the foregoing embodiments.

As shown in FIG. 2, the method includes:

S210: Obtain current object information of a target object and historical state information of a target element, where the current object information comprises current pose information and current speed information; and/or the historical state information comprises previous state information of the target element in a previous image frame, and the target element is associated with the target object.

S220: Encode the current pose information.

In this embodiment, the current object information may include current pose information and current speed information. The current pose information may refer to pose information of the target object in the current image frame, for example, may be a body skeleton parameter. The current speed information may refer to speed information of the target object in the current image frame, for example, may be a speed parameter. The historical state information may include previous state information of the target element in a previous image frame.

After the foregoing information is obtained, the current pose information may be first encoded, and the current pose information may be encoded into information in the form of feature parameter, thereby obtaining the encoded current pose information. A specific encoding means may be, for example, inputting the current pose information into an encoding module to output the encoded current pose information.

S230: Determine current state information of the target element based on the encoded current pose information, the current speed information, and the previous state information, where the current state information is state information of the target element in the current image frame.

The current state information may be state information of the target element in the current image frame.

Specifically, in this step, the current state information of the target element may be determined based on the encoded current pose information, the current speed information, and the previous state information, for example, the corresponding current state information may be determined by inputting the encoded current pose information, the current speed information, and the previous state information into a timing module, or the current state information of the target element may be obtained by calculating the encoded current pose information, the current speed information, and the previous state information.

S240: Decode the current state information to obtain the current pose information of the target element, where the current pose information is pose information of the target element in the current image frame.

After the current state information is obtained, the obtained current state information may be decoded to obtain the current pose information of the target element. A specific process of decoding is not limited. For example, the state information of all nodes in the target object may be directly decoded to be used as the current pose information of the target element.

In some embodiments, obtaining the current pose information of the target element by decoding the current state information comprises:

obtaining the current pose information corresponding to the target element by decoding the current state information using a chain decoding method.

In some implementations, the current state information may be decoded in the chain decoding method to obtain the current pose information corresponding to the target element. For example, the state information of element nodes included in the target object may be sequentially determined in the chain decoding method, to obtain the current pose information of the target element. This embodiment is not described in further detail herein, as long as the current pose information of the target element can be obtained.

In the pose determination method provided in the embodiments of the present disclosure, current object information of a target object and historical state information of a target element are obtained, where the current object information comprises current pose information and current speed information; and/or the historical state information comprises previous state information of the target element in a previous image frame, and the target element is associated with the target object; the current pose information is encoded; current state information of the target element is determined based on the encoded current pose information, the current speed information, and the previous state information, where the current state information is state information of the target element in the current image frame; and the current state information is decoded to obtain the current pose information of the target element, where the current pose information is pose information of the target element in the current image frame. By using the method, the current state information of the target element is determined based on the encoded current pose information, the current speed information, and the previous state information, and the obtained current state information is decoded, so that the current pose information of the target element can be quickly obtained, thereby further improving the efficiency of determining element pose information.

In some embodiments, decoding the current state information using the chain decoding method comprises:
sequentially determining each element node in the target element as a current element node based on a position relationship of element nodes in the target element;
obtaining a preset feature vector and parent node information of the current element node, where the parent node information is node state information of a parent node, and parent node information of a first element node in the target element is the current state information; and
determining node state information of the current element node based on the preset feature vector and the parent node information.

The element node may be understood as a plurality of nodes obtained by segmenting the target element, for example, bone nodes. The preset feature vector is used to represent feature information of the element node, for example, the preset feature vector of each element node may be pre-configured. The parent node information may be node state information of the parent node, for example, may be node state information of a previous element segment of the current element node. The parent node information of the first element node in the target element may be the current state information. The first element node may be, for example, a first element segment in the target element. The current element node may be an element node for which node state information needs to be determined currently.

Specifically, each element node in the target element may be sequentially used as the current element node based on the position relationship between the element nodes in the target element. Exemplarily, the first element node in the target element may be first used as the current element node. In this case, the preset feature vector of the current element node may be obtained, and the determined current state information may be obtained as parent node state information of the first element node. Then, the node state information of the first element node may be determined based on the preset feature vector and the parent node state information. Next, a next element node of the first element node may be determined as the current element node. The node state information of the next element node may be determined by obtaining a preset feature vector of the next element node and the node state information of the first element node. By analogy, the node state information of all element nodes may be obtained in the foregoing manner and used as the current pose information of the target element.

For another example, the decoding module in this embodiment may further use a variant to sacrifice certain inference performance to improve the inference precision. For example, a gated recurrent unit nn.Gru of a neural network may be arranged in the decoder, so that a feature of each bone may be gradually generated according to a parent-child node relationship through nn.Gru, and then decoded into a corresponding bone parameter (that is, node state information).

In some embodiments, the current pose information is a preset rotation parameter of the target object, and the preset rotation parameter includes Euler angles, a quaternion, 6D rotation parameters, or a rotation matrix.

In some implementations, the preset rotation parameter may include Euler angles, a quaternion, 6D rotation parameters, or a rotation matrix. Optionally, the current pose information in this embodiment may be 6D rotation parameters of the target object. That is, the current pose information may be determined in a rot6d form during a specific operation, so as to facilitate subsequent calculation and improve the effect of determining the current pose information.

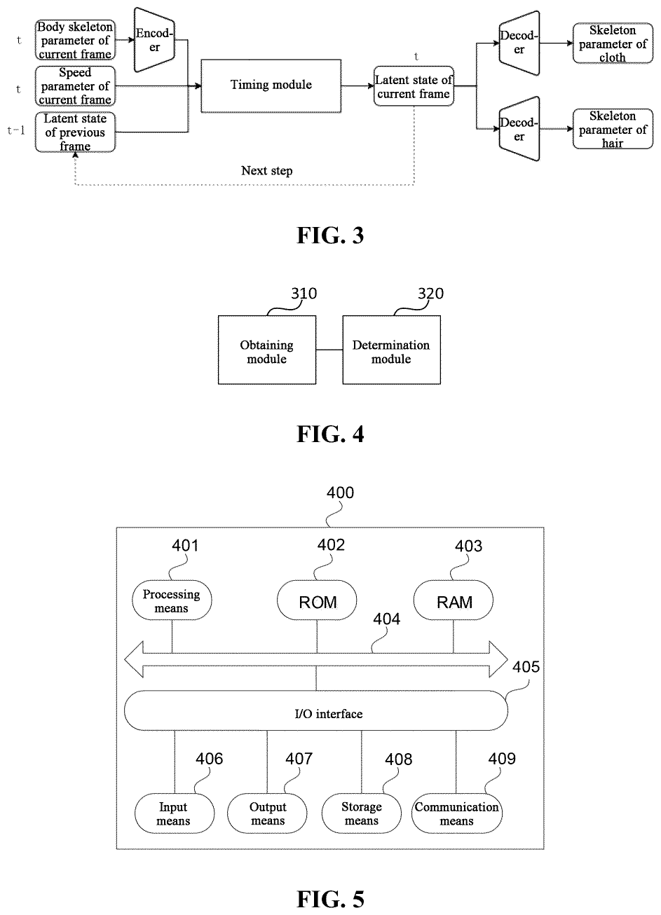

FIG. 3 is a schematic flowchart of another pose determination method according to embodiments of the present disclosure. As shown in FIG. 3, taking the target element including clothes and hair as an example, because a result of each frame of dynamic physical simulation depends on a state of a previous K frames (such as a speed and an acceleration), and considering factors such as an inference speed, in the embodiments of the present disclosure, a network may be designed based on a timing neural network (such as a preset pose determination model), that is, historical information is uniformly stored in a state vector, and is used for dynamic effect prediction of a current frame.

The input of the timing neural network may include a body skeleton parameter, a speed parameter, and a latent state of a previous frame (that is, obtaining current object information of a target object and historical state information of a target element, where the current object information includes current pose information and current speed information; and/or the historical state information includes previous state information of the target element in a previous image frame). The data form of the body skeleton parameter may be, for example, batchsize(1)*bone_num(N1)*bone_dim(6), where 1 represents one character, N1 is the number of bones in a body skeleton of the character, and 6 may be a 6-dimensional rotation matrix. The data form of the speed parameter may be, for example, batchsize(1)*speed_dim(3). The data form of the latent state of the previous frame may be, for example, batchsize (1)*latent_state_dim(256). The output of the timing neural network may include the skeleton parameter of the hair and the clothes. The data form may be, for example, batchsize(1)*bone_num (N2+N3)*dim(6), where N2 and N3 are respectively the number of bones in the skeleton of the clothes and the number of bones in the skeleton of the hair.

Specifically, the body skeleton parameter of the current frame may be encoded into a feature parameter through an encoder (that is, an encoding module), and then input into a timing module in the timing neural network together with the speed parameter of the current frame and the latent state of the previous frame to obtain a latent state of the current frame. Then, the latent state of the current frame may be respectively input into different decoders (that is, decoding modules) to generate skeleton parameters of different parts.

An encoder and a decoder may use the same MLP-based structure. At the same time, an nn.LayerNorm layer and an nn.GELU layer may be added after each linear layer to improve the network precision. The timing module may use nn.GRUcell to process timing information. This module can take into account both performance and calculation efficiency.

Compared with the existing simulation plug-in, the embodiments of the present disclosure can replace the traditional simulation plug-in to simulate the target element, thereby achieving acceleration.

In addition, the embodiments of the present disclosure are designed based on a timing neural network, and solve the problem that machine learning deformer (MLD) technology cannot support dynamic physical simulation. Specifically, the problem to be solved by MLD is muscle simulation and cloth wrinkle simulation (static simulation). The input is the skeleton parameters of the current frame, and the output is the cloth vertex parameters. The model is mainly a multi-layer MLP. The problem to be solved in this embodiment is dynamic element simulation. The input parameters are the skeleton parameters and the historical state parameters of the current frame, and the output is the element skeleton parameters and the current state parameters. The model is MLP (+layernorm&gelu)+GRU. For example, an encoder and a decoder serve as MLPs, and a GRU is located between the two MLPs and is used to process a historical state quantity.

Therefore, when facing a game with a large number of users, especially a user generated content (UGC) game, using the solution provided in the embodiments of the present disclosure can effectively improve the smoothness of such a game while ensuring an element simulation effect.

FIG. 4 is a schematic diagram of a structure of a pose determination apparatus according to embodiments of the present disclosure. The apparatus is applicable to a case of determining a pose. The apparatus may be implemented by software and/or hardware, and is generally integrated on an electronic device.

As shown in FIG. 4, the apparatus includes:
an obtaining module 310, configured to obtain current object information of a target object and historical state information of a target element, where the current object information is object information of the target object in a current image frame, the historical state information is state information of the target element in a historical image frame, and the target element is associated with the target object; and
a determination module 320, configured to determine current pose information of the target element based on the current object information and the historical state information, where the current pose information is pose information of the target element in the current image frame.

In the pose determination apparatus provided in the embodiments of the present disclosure, the obtaining module is configured to obtain current object information of a target object and historical state information of a target element, where the current object information is object information of the target object in a current image frame, the historical state information is state information of the target element in a historical image frame, and the target element is associated with the target object; and the determination module is configured to determine current pose information of the target element based on the current object information and the historical state information, where the current pose information is pose information of the target element in the current image frame. By using the apparatus, the current pose information of the target element is determined based on the obtained current object information and historical state information, so that the efficiency of determining element pose information is effectively improved, and a problem of dynamic element simulation is solved.

Optionally, the current object information comprises current pose information and current speed information; and/or the historical state information comprises previous state information of the target element in a previous image frame.

Optionally, the determination module comprises:
an encoding processing unit, configured to encode the current pose information;
a determination unit, configured to determine current state information of the target element based on the encoded current pose information, the current speed information, and the previous state information, where the current state information is state information of the target element in the current image frame; and
a decoding processing unit, configured to obtain the current pose information of the target element by decoding the current state information.

Optionally, the decoding processing unit comprises:
a decoding sub-processing unit, configured to obtain the current pose information corresponding to the target element by decoding the current state information using a chain decoding method.

Optionally, the decoding sub-processing unit is specifically configured to:
sequentially determine each of element nodes in the target element as a current element node based on position relationships of the element nodes in the target element;
obtain a preset feature vector and parent node information of the current element node, where the parent node information is node state information of a parent node, and parent node information of a first element node in the target element is the current state information; and
determine node state information of the current element node based on the preset feature vector and the parent node information.

Optionally, the current pose information is a preset rotation parameter of the target object, and the preset rotation parameter comprises an Euler angle, a quaternion, a 6D rotation parameter, or a rotation matrix.

Optionally, the pose determination apparatus provided in the embodiments of the present disclosure further comprises:
a generation module, configured to generate the current image frame based on the current object information and the current pose information after determining the current pose information of the target element based on the current object information and the historical state information, where the current image frame is presented with an object image of the target object and/or an element image of the target element.

Optionally, the determination module is specifically configured to:
input the current object information and the historical state information into a preset pose determination model, and obtaining pose information output by the preset pose determination model, as the current pose information of the target element.

Optionally, the preset pose determination model comprises an encoding module, a timing module, and at least one decoding module, the encoding module is configured to encode the current pose information in the current object information, the timing module is configured to determine current state information of the target element, and the decoding module is configured to decode the current state information.

Optionally, different decoding modules correspond to different target elements, and are configured obtain current pose information corresponding to target elements by decoding.

Optionally, the encoding module and the decoding module are multi-layer perception structures, and the multi-layer perception structures comprises a plurality of linear layers, and output sides of at least part of the linear layers are configured with a normalization layer and/or a Gaussian error linear unit.

Optionally, a loss function of the preset pose determination model comprises a forward dynamics loss function, and the forward dynamics loss function is based on wavelet transform for frequency decomposition.

The foregoing pose determination apparatus may perform the pose determination method provided in any embodiment of the present disclosure, and has corresponding functional modules and beneficial effects for performing the method.

Reference is made below to FIG. 5, which is a schematic diagram of a structure of an electronic device 400 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 400 may include a processing means (for example, a central processing unit, a graphics processing unit, or the like) 401 that may perform a variety of appropriate actions and processing in accordance with a program stored in a read-only memory (ROM) 402 or a program loaded from a storage means 408 into a random access memory (RAM) 403. The RAM 403 further stores various programs and data required for the operation of the electronic device 400. The processing means 401, the ROM 402, and the RAM 403 are connected to each other through a bus 404. An input/output (I/O) interface 405 is also connected to the bus 404.

Generally, the following apparatuses may be connected to the I/O interface 405: an input means 406 including, for example, a touch image, a touchpad, a keyboard, a mouse, a camera, a microphone, an accelerometer, a gyroscope, or the like; an output means 407 including, for example, a liquid crystal display (LCD), a speaker, a vibrator, or the like; the storage means 408 including, for example, a tape and a hard disk; and a communication means 409. The communication means 409 may allow the electronic device 400 to perform wireless or wired communication with other devices to exchange data. Although FIG. 5 shows the electronic device 400 having various apparatuses, it should be understood that it is not required to implement or have all of the shown apparatuses. It may be an alternative to implement or have more or fewer apparatuses.

In particular, according to embodiments of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication means 409, or installed from the storage means 408, or installed from the ROM 402. When the computer program is executed by the processing means 401, the above-described functions defined in the method of the embodiment of the present disclosure are performed.

It should be noted that the computer-readable medium described above in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (such as the Internet), a peer-to-peer network (such as an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs, and when the one or more programs are executed by the electronic device, the electronic device is caused to: obtain current object information of a target object and historical state information of a target element, where the current object information is object information of the target object in a current image frame, the historical state information is state information of the target element in a historical image frame, and the target element is associated with the target object; and determine current pose information of the target element based on the current object information and the historical state information, where the current pose information is pose information of the target element in the current image frame.

Computer program code for performing operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate possible system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a pose determination method, including:
obtaining current object information of a target object and historical state information of a target element, where the current object information is object information of the target object in a current image frame, the historical state information is state information of the target element in a historical image frame, and the target element is associated with the target object; and
determining current pose information of the target element based on the current object information and the historical state information, where the current pose information is pose information of the target element in the current image frame.

According to one or more embodiments of the present disclosure, Example 2 is the method according to Example 1, where the current object information comprises current pose information and current speed information; and/or the historical state information comprises previous state information of the target element in a previous image frame.

According to one or more embodiments of the present disclosure, Example 3 is the method according to Example 2, where determining the current pose information of the target element based on the current object information and the historical state information comprises:
encoding the current pose information;
determining current state information of the target element based on the encoded current pose information, the current speed information, and the previous state information, where the current state information is state information of the target element in the current image frame; and
obtaining the current pose information of the target element by decoding the current state information.

According to one or more embodiments of the present disclosure, Example 4 is the method according to Example 3, where obtaining the current pose information of the target element by decoding the current state information comprises:
obtaining the current pose information corresponding to the target element by decoding the current state information using a chain decoding method.

According to one or more embodiments of the present disclosure, Example 5 is the method according to Example 4, where decoding the current state information using the chain decoding method comprises:
sequentially determining each of element nodes in the target element as a current element node based on position relationships of the element nodes in the target element;
obtaining a preset feature vector and parent node information of the current element node, where the parent node information is node state information of a parent node, and parent node information of a first element node in the target element is the current state information; and
determining node state information of the current element node based on the preset feature vector and the parent node information.

According to one or more embodiments of the present disclosure, Example 6 is the method according to Example 2, where the current pose information is a preset rotation parameter of the target object, and the preset rotation parameter comprises an Euler angle, a quaternion, a 6D rotation parameter, or a rotation matrix.

According to one or more embodiments of the present disclosure, Example 7 is the method according to Example 1, where the method further comprises, after determining current pose information of the target element based on the current object information and the historical state information:
generating the current image frame based on the current object information and the current pose information, where the current image frame is presented with an object image of the target object and/or an element image of the target element.

According to one or more embodiments of the present disclosure, Example 8 is the method according to any of Examples 1 to 7, where the determining current pose information of the target element based on the current object information and the historical state information comprises:
inputting the current object information and the historical state information into a preset pose determination model, and obtaining pose information output by the preset pose determination model, as the current pose information of the target element.

According to one or more embodiments of the present disclosure, Example 9 is the method according to Example 8, where the preset pose determination model comprises an encoding module, a timing module, and at least one decoding module, the encoding module is configured to encode the current pose information in the current object information, the timing module is configured to determine current state information of the target element, and the decoding module is configured to decode the current state information.

According to one or more embodiments of the present disclosure, Example 10 is the method according to Example 9, where different decoding modules correspond to different target elements, and are configured to obtain current pose information corresponding to target elements by decoding.

According to one or more embodiments of the present disclosure, Example 11 is the method according to Example 9, where the encoding module and the decoding module are multi-layer perception structures, and the multi-layer perception structures comprises a plurality of linear layers, and output sides of at least part of the linear layers are configured with a normalization layer and/or a Gaussian error linear unit.

According to one or more embodiments of the present disclosure, Example 12 is the method according to Example 9, where a loss function of the preset pose determination model comprises a forward dynamics loss function, and the forward dynamics loss function is based on wavelet transform for frequency decomposition.

According to one or more embodiments of the present disclosure, Example 13 provides a pose determination apparatus, including:
an obtaining module, configured to obtain current object information of a target object and historical state information of a target element, where the current object information is object information of the target object in a current image frame, the historical state information is state information of the target element in a historical image frame, and the target element is associated with the target object; and
a determination module, configured to determine current pose information of the target element based on the current object information and the historical state information, where the current pose information is pose information of the target element in the current image frame.

According to one or more embodiments of the present disclosure, Example 14 provides an electronic device, including:
one or more processors; and
a memory, configured to store one or more programs,
where when the one or more programs are executed by the one or more processors, the one or more processors are caused to implement the pose determination method according to any of Examples 1 to 12.

According to one or more embodiments of the present disclosure, Example 15 provides a computer-readable storage medium having a computer program stored thereon, where when the program is executed by a processor, the pose determination method according to any of Examples 1 to 12 is implemented.

The foregoing descriptions are merely preferred embodiments of the present disclosure and explanations of the applied technical principles. Persons skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features having similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

The invention claimed is:

1. A pose determination method, comprising:
obtaining current object information of a target object and historical state information of a target element, wherein the current object information is object information of the target object in a current image frame, the historical state information is state information of the target element in a historical image frame, and the target element is associated with the target object; and
determining current pose information of the target element based on the current object information and the historical state information, wherein the current pose information is pose information of the target element in the current image frame.

2. The method according to claim 1, wherein the current object information comprises current pose information and current speed information; and/or the historical state information comprises previous state information of the target element in a previous image frame.

3. The method according to claim 2, wherein determining the current pose information of the target element based on the current object information and the historical state information comprises:
encoding the current pose information;
determining current state information of the target element based on the encoded current pose information, the current speed information, and the previous state information, wherein the current state information is state information of the target element in the current image frame; and
obtaining the current pose information of the target element by decoding the current state information.

4. The method according to claim 3, wherein obtaining the current pose information of the target element by decoding the current state information comprises:
obtaining the current pose information corresponding to the target element by decoding the current state information using a chain decoding method.

5. The method according to claim 4, wherein decoding the current state information using the chain decoding method comprises:
sequentially determining each of element nodes in the target element as a current element node based on position relationships of the element nodes in the target element;
obtaining a preset feature vector and parent node information of the current element node, wherein the parent node information is node state information of a parent node, and parent node information of a first element node in the target element is the current state information; and
determining node state information of the current element node based on the preset feature vector and the parent node information.

6. The method according to claim 2, wherein the current pose information is a preset rotation parameter of the target object, and the preset rotation parameter comprises an Euler angle, a quaternion, a 6D rotation parameter, or a rotation matrix.

7. The method according to claim 1, further comprising, after determining the current pose information of the target element based on the current object information and the historical state information:
generating the current image frame based on the current object information and the current pose information, wherein the current image frame is presented with an object image of the target object and/or an element image of the target element.

8. The method according to claim 1, wherein determining the current pose information of the target element based on the current object information and the historical state information comprises:
inputting the current object information and the historical state information into a preset pose determination model, and obtaining pose information output by the preset pose determination model, as the current pose information of the target element.

9. The method according to claim 8, wherein the preset pose determination model comprises an encoding module, a timing module, and at least one decoding module, the encoding module is configured to encode the current pose information in the current object information, the timing module is configured to determine current state information of the target element, and the decoding module is configured to decode the current state information.

10. The method according to claim 9, wherein different decoding modules correspond to different target elements, and are configured to obtain current pose information corresponding to target elements by decoding.

11. The method according to claim 9, wherein the encoding module and the decoding module are multi-layer perception structures, and the multi-layer perception structures comprises a plurality of linear layers, and output sides of at least part of the linear layers are configured with a normalization layer and/or a Gaussian error linear unit.

12. The method according to claim 9, wherein a loss function of the preset pose determination model comprises a forward dynamics loss function, and the forward dynamics loss function is based on wavelet transform for frequency decomposition.

13. An electronic device, comprising:
at least one processor; and
a memory communicatively connected to the at least one processor; wherein
the memory is stored with a computer program executable by the at least one processor, and the computer program, when executed by the at least one processor, causes the at least one processor to:
obtain current object information of a target object and historical state information of a target element, wherein the current object information is object information of the target object in a current image frame, the historical state information is state information of the target element in a historical image frame, and the target element is associated with the target object; and
determine current pose information of the target element based on the current object information and the historical state information, wherein the current pose information is pose information of the target element in the current image frame.

14. The device according to claim 13, wherein the current object information comprises current pose information and current speed information; and/or the historical state information comprises previous state information of the target element in a previous image frame.

15. The device according to claim 14, wherein the computer program causing the at least one processor to determine the current pose information of the target element based on the current object information and the historical state information further causes the at least one processor to:
encode the current pose information;
determine current state information of the target element based on the encoded current pose information, the current speed information, and the previous state information, wherein the current state information is state information of the target element in the current image frame; and
obtain the current pose information of the target element by decoding the current state information.

16. The device according to claim 15, wherein the computer program causing the at least one processor to obtain the current pose information of the target element by decoding the current state information further causes the at least one processor to:
obtain the current pose information corresponding to the target element by decoding the current state information using a chain decoding method.

17. The device according to claim 16, wherein the computer program causing the at least one processor to decode the current state information using the chain decoding method comprises further causes the at least one processor to:
sequentially determine each of element nodes in the target element as a current element node based on position relationships of the element nodes in the target element;
obtain a preset feature vector and parent node information of the current element node, wherein the parent node information is node state information of a parent node, and parent node information of a first element node in the target element is the current state information; and
determine node state information of the current element node based on the preset feature vector and the parent node information.

18. The device according to claim 14, wherein the current pose information is a preset rotation parameter of the target object, and the preset rotation parameter comprises an Euler angle, a quaternion, a 6D rotation parameter, or a rotation matrix.

19. The device according to claim 13, wherein the computer program further causes the at least one processor to, after determining the current pose information of the target element based on the current object information and the historical state information:
generate the current image frame based on the current object information and the current pose information, wherein the current image frame is presented with an object image of the target object and/or an element image of the target element.

20. A non-transitory computer-readable storage medium, wherein the computer-readable storage medium is stored with computer instructions, and the computer instructions, when executed by a processor, cause the processor to:
obtain current object information of a target object and historical state information of a target element, wherein the current object information is object information of the target object in a current image frame, the historical state information is state information of the target element in a historical image frame, and the target element is associated with the target object; and
determine current pose information of the target element based on the current object information and the historical state information, wherein the current pose information is pose information of the target element in the current image frame.
